(19) United States
(12) Patent Application Publication
(10) Pub. No.: US 2013/0339868 A1
(43) Pub. Date: Dec. 19, 2013

(54) SOCIAL NETWORK

(71) Applicant: HEARTS ON FIRE COMPANY, LLC, Boston, MA (US)

(72) Inventors: ARTHUR SHARPE, SCITUATE, MA (US); CARYL CAPECI, WAYLAND, MA (US); CHRISTINA YEE, NEWTON, MA (US); LEEANNA DIEHL, SOMERVILLE, MA (US); ANGELA MARTIN, SOUTH BOSTON, MA (US); WAYNE STOTT, BOSTON, MA (US)

(21) Appl. No.: 13/904,592

(22) Filed: May 29, 2013

Related U.S. Application Data
(60) Provisional application No. 61/653,179, filed on May 30, 2012.

(51) Int. Cl. G06F 3/0481

(52) U.S. Cl. CPC G06F 3/04817
USPC 715/739

(57) ABSTRACT

Social networks may include computers which cause information to be displayed on maps. A computer may receive temporal and geographic data comprising a location and a moment in time linked to one another, and the temporal and geographic data being associated with an icon linked to a position on a map. The computer may receive a command to filter the icon based on a period of time. The computer may cause a portion of the map to be displayed and the icon to be displayed at the linked position on the portion of the map when the moment in time is within the time period and the location is within the portion of the map. The computer may determine that the icon is not to be displayed when the moment in time is not within the time period and/or the location is not within the portion of the map.

### CROSS-REFERENCE TO RELATED APPLICATIONS

This application is based on and derives the benefit of the filing date of U.S. Provisional Patent Application No. 61/653,179, filed May 30, 2012. The entire content of this application is herein incorporated by reference in its entirety.

### BRIEF DESCRIPTION OF THE DRAWINGS

FIG. 1 depicts an example network according to an embodiment of the invention.

FIG. 2 depicts an example landing page according to an embodiment of the invention.

FIG. 3 depicts an example map view according to an embodiment of the invention.

FIG. 4 depicts an example world view according to an embodiment of the invention.

FIG. 5 depicts an example map view with an example add moment faun according to an embodiment of the invention.

FIG. 6 depicts an example map control process according to an embodiment of the invention.

FIG. 7 depicts an example timeline control process according to an embodiment of the invention.

FIG. 8 depicts an example moment in history process according to an embodiment of the invention.

FIG. 9 depicts an example add moment process according to an embodiment of the invention.

FIG. 10 depicts an example image upload process according to an embodiment of the invention.

### DETAILED DESCRIPTION OF SEVERAL EMBODIMENTS

Systems and methods described herein may provide social networks enabling users to access and share information associated with moments in time at various locations. A social network may comprise one or more computers which may be linked to one another via an existing or proprietary network or networks. A computer may be any programmable machine capable of performing arithmetic and/or logical operations. In some embodiments, computers may comprise circuits, processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant art, such as servers, PCs, mobile devices, and other terms. It will be understood by those of ordinary skill that those terms used herein are interchangeable, and any computer capable of performing the described functions may be used. For example, though the term “server” may appear in the following specification, the disclosed embodiments are not limited to servers.

A network, such as a social network, may be any plurality of completely or partially interconnected computers wherein some or all of the computers are able to communicate with one another. It will be understood by those of ordinary skill that connections between computers may be wired in some cases (i.e. via Ethernet, coaxial, optical, or other wired connection) or may be wireless (i.e. via WiFi, WiMax, or other wireless connection). Connections between computers may use any protocols, including connection oriented protocols such as TCP or connectionless protocols such as UDP. Any connection through which at least two computers may exchange data may be the basis of a network.

A social network may be a network that may enable users to register with the network, create profiles and/or content on the network, share information with other network users, and/or receive information shared by other network users. Note that in many example embodiments described below, social networks are described in the context of “perfect moments” or “moments”, wherein social network users may share and/or view information about moments in time and/or place. For example, perfect moments may be moments of sentimental or historical interest to a user. It will be understood that sharing and/or viewing perfect moments are provided as example uses for a social network, and embodiments described below may be used to share and/or view any type of information.

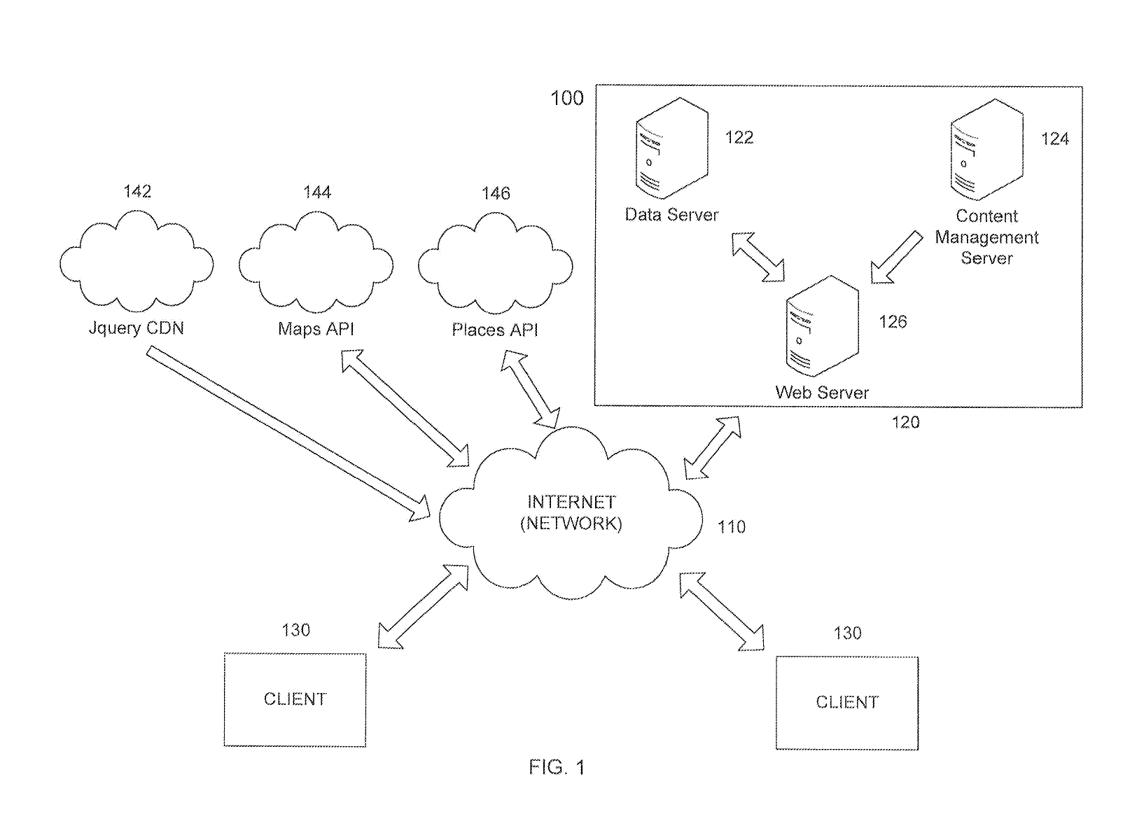

FIG. 1 depicts an example network 100 according to an embodiment of the invention. One or more servers may provide social network services 120. For example, a data server 122 and content management server 124 may be in communication with a web server 126, and the web server 126 may in turn be in communication with the Internet 110 or another network. The web server 126 may provide Internet 110 access to the other social network services 120 computers. The web server 126 may also store graphics and/or user uploaded images. The data server 122 may contain one or more databases containing data used to perform the methods and/or enable the systems described in greater detail below. The web server 126 may retrieve data from the data server 122 and send the data to remote computers (such as client devices 130) via the Internet. The content management server 124 may configure static text and moments as described in greater detail below. Data in the content management server 124 may be pushed periodically to the web server 126 for transmission to remote computers (such as client devices 130) via the Internet. Those of ordinary skill in the art will appreciate that the data server 122, content management system 124, and/or web server 126 may each comprise one or more computers, and functions performed by the data server 122, content management system 124, and/or web server 126 may be performed by a single computer or divided among a plurality of computers in any arrangement.

One or more client devices 130 may also be in communication with the Internet 110 or other network. Communications between the web server 126 and client devices 130 may be made via the Internet 110 and/or through other channels. Client devices 130 may be any types of computers, for example PCs or mobile devices such as smart phones or tablet devices. The client devices 130 may include dedicated software for interacting with the web server 126 via the Internet 110 and/or may interact with the web server 126 via the Internet 110 using a web browser. As will be described in greater detail below, users of the client devices 130 may cause the client devices 130 to receive information from and/or send commands to the computers providing social network services 120.

Other computers may also be in communication with the web server 126 and/or client devices 130 via the Internet 110. For example, JQuery content delivery network (CDN) computers 142, map application programming interface (API) computers 144, and/or places API computers 146 may be in communication with social network services 120 through, for example, the Internet 110 or directly. In some embodiments, the Jquery CDN computers 142, map API computers 144, and/or places API computers 146 may be publicly accessible servers such as those provided by Google. Those of ordinary skill in the art will appreciate that these services may also be provided by dedicated and/or private systems or be performed by computers that also provide social network services 120.

An example JQuery CDN 142 may be a download service provided by Google or a similar provider. This service may facilitate the download of a JQuery framework to a requesting device. Once this framework is downloaded, it may be used as an interface for client scripting on the device (for example with Javascript). This framework may be used for animation, requesting data from a web server, and/or for monitoring events on the device. This may be a read only service wherein no data is ever posted back to the CDN.

An example map API 144 may be a service provided by Google or a similar provider to render a map, pins, map controls, and/or animated overlays. This service may provide interactive methods that may allow a map's usability to be controlled and/or altered. It also may handle external geolocation requests and/or address lookups. Data may be passed back and forth from the Google map API 144 to the web server 126 to generate application interactivity. For example, when the map is zoomed, the API 144 may let the application know that a zoom event has been fired. The application may then request the new zoom level and/or center latitude and longitude from the map API 144.

An example places API 146 may be another service provided by Google or a similar provider. When address or location data is sent to this API 146, the API 146 may respond with human readable information about a particular location (for example, business name, point of interest name, etc.). The API 146 may also provide auto complete information to some input fields (for example, a user may start to type “Disn” and the API 146 may respond with “Disney World”).

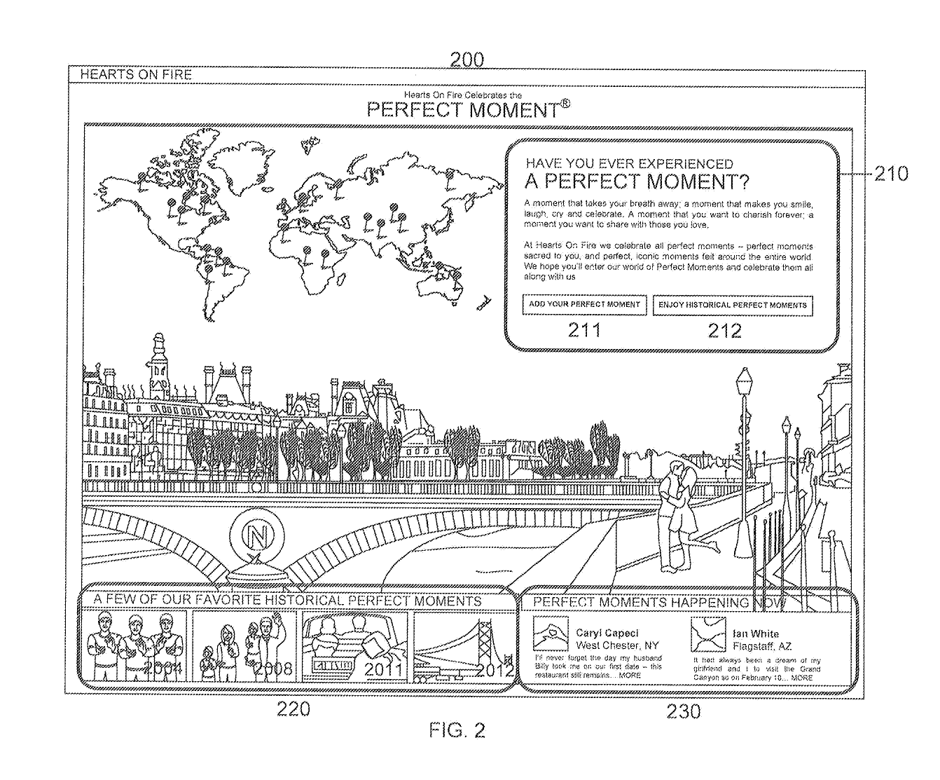

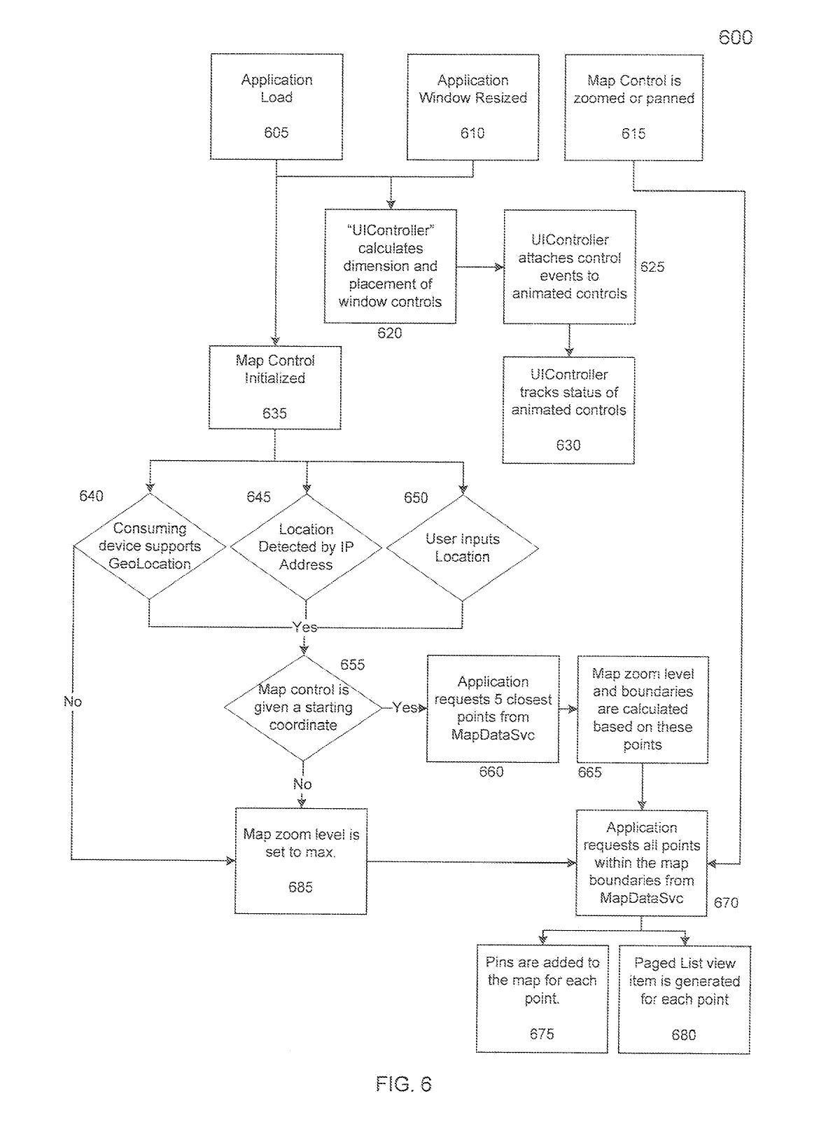

FIGS. 2-5 depict example social network 100 user interfaces which may be delivered to a client device 130 by a web server 126 and/or generated by a client device 130. FIGS. 6-10 depict example processes by which these interfaces and/or content associated with these interfaces may be controlled by social network services computers 120 and/or client devices 130.

FIG. 2 depicts an example landing page 200 according to an embodiment of the invention. The landing page 200 and/or associated data may be stored on the web server 126 and/or other social network services computers 120 in some embodiments. A server, such as the web server 126, may receive a request for the landing page 200 from a client device 130 via the Internet 110. In response, the web server 126 may transmit landing page 200 data to the client device 130 via the Internet 110, and the landing page 200 may be displayed on a display associated with the client device 130. In an example of a web based landing page 200, all presentation may be generated by a social network services computer 120 and presented to a web browser associated with the client device 130 for rendering. The content may have a Javascript component which may run natively in the web browser. In an example of a dedicated application, such as an iPhone application, the landing page 200 may be part of the standalone application. Variable data may be presented to the application from a social network services computer 120 for rendering on the client device 130. In some embodiments, the landing page 200, and/or other pages described below, may be tailored for display on particular client devices 130 based on the hardware and/or software used by the client devices 130. In some embodiments, the landing page 200, and/or other pages described below, may be generated and/or provided using JavaScript object notation (JSON) objects and/or other techniques.

The example landing page 200 of FIG. 2 includes user interfaces enabling a user of a client device 130 to request additional content and/or interfaces from the web server 126. For example, a general content interface 210 may be provided. As shown in this example, the general content interface 210 may provide options to add user generated content 211, such as user generated moments, and/or to view previously added and/or stored content 212, such as moments added by users previously and/or historical moments generated by an operator of the social network 100 or other content provider. The landing page 200 may also display links to stored content 220 and/or a ticker 230 which may display content generated by other users of the social network 100. Stored content may be content, such as historical moments, that is provided by an operator of the social network 100, rather than individual users, in some embodiments. The ticker 230 may be updated as new content, such as user generated moments, is added and/or at other times.

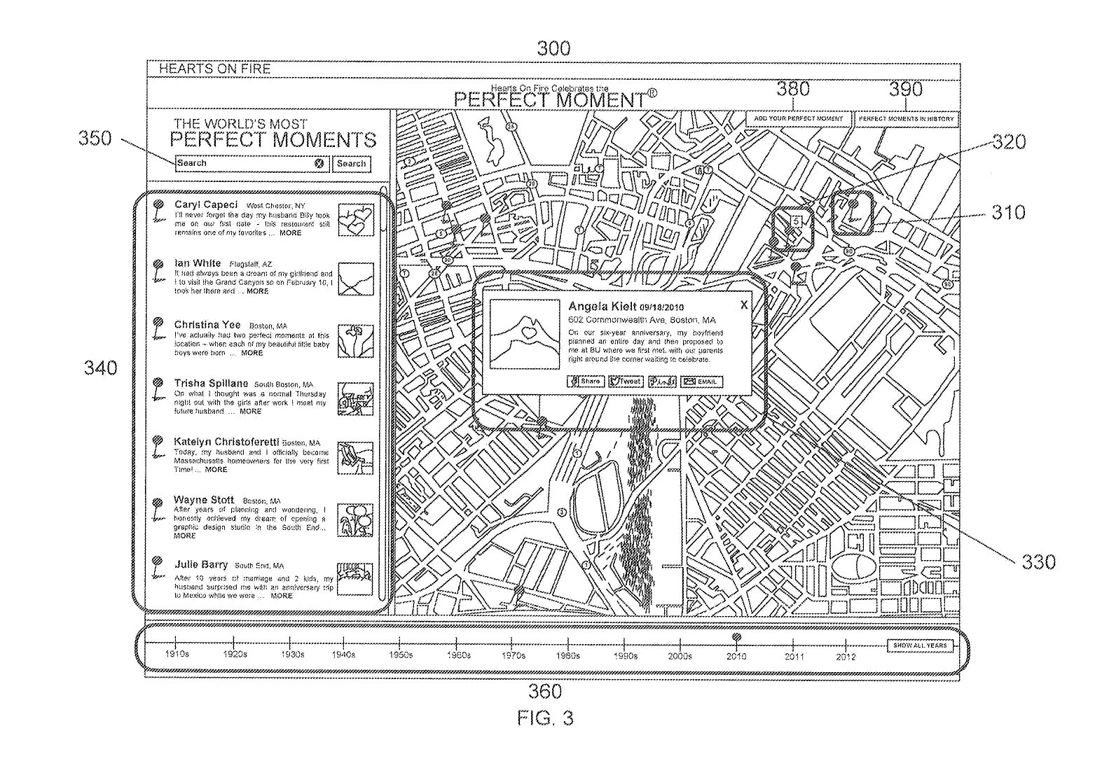

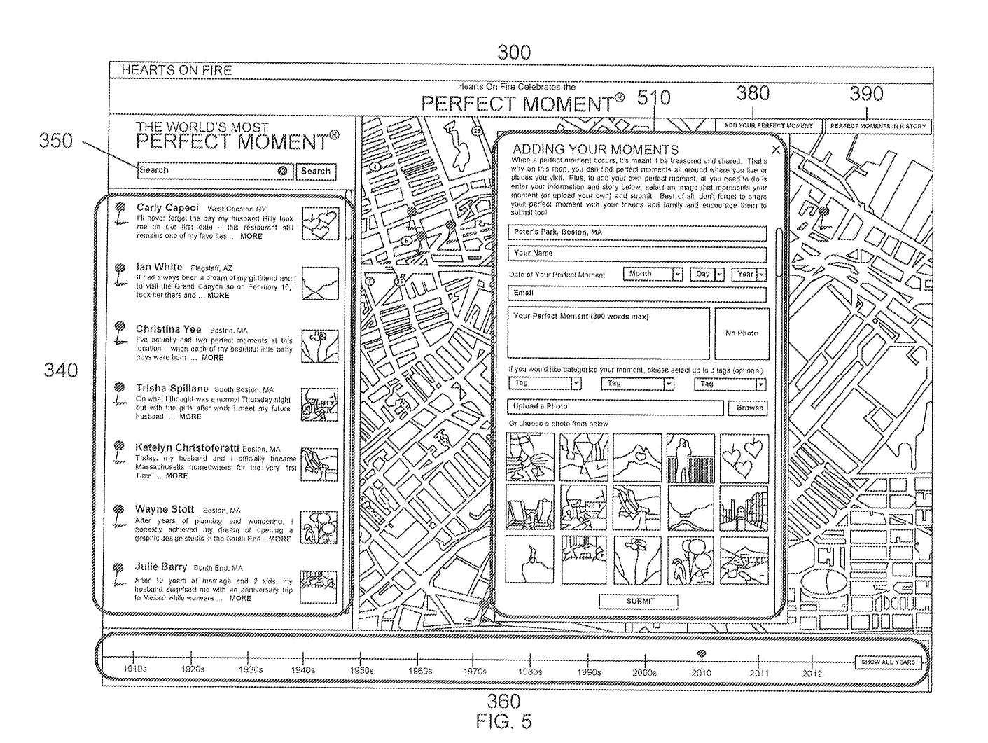

Users may be able to select links associated with the moments or other content in the stored content 220 display and/or the ticker 230. Selecting a link associated with a moment and/or a link to view previously added and/or stored moments 212 may cause the client device 130 to request a map page 300 from the web server 126. Map pages 300 are described in greater detail with respect to FIG. 3 below. Selecting a link to add user generated content 211 may cause the client device 130 to request an add content form 500 from the web server 126. Add content forms 500 are described in greater detail with respect to FIG. 5 below. The landing page 200 may also display background images, logos, and/or the like.

FIG. 3 depicts an example map view 300 according to an embodiment of the invention.

As with the landing page 200, some or all of the map view 300 data may be stored on the web server 126 and/or other social network services computers 120 in some embodiments. In other embodiments, map data may be provided by an external map server 144, for example Google Maps or another service, and social network 100 data may be incorporated with the external map data. For example, a social network application running on the client device 130 may receive data from the map server 144 and social network web server 126 and display the data from the social network web server 126 on a map from the map server 144. When a map view 300 is loaded on a client device 130, it may be centered on a client device location 130 (which may be provided by a user, previously stored in a memory in the client device 130, determined from client device 130 GPS and/or cell triangulation, etc.). In some embodiments, centering on a client device 130 location may be a default action when the map view 300 is requested and loaded.

As noted above, moments displayed by the social network 100 may be moments in time and/or place. Accordingly, moments may be displayed on the map view 300 as pins 310 or other visual indicators which may be fixed to a map location based on address, GPS coordinates, or other criteria. If multiple moments are associated with one place (or are very close to one another), a grouped pin 320 or other visual indicator may be used to represent the entire group of moments. Whether multiple moments are close enough to one another to be grouped may depend on a map view 300 zoom level in some embodiments. For example, zooming in on the map view 300 may cause previously grouped moments to become sufficiently spread out on the map view 300 to be given separate pins 310. Conversely, zooming out on the map 300 may cause separate moments to become sufficiently close on the map display 300 to be grouped with a grouped pin 320. In the example embodiment of FIG. 3, the grouped pin 320 includes a number indicating the number of moments associated with the grouped pin 320. In some embodiments, user generated moments and moments supplied by a social network operator may be grouped separately with separate grouped pins 320, even when they are close to one another. When a map view 300 is loaded on a client device 130, its initial zoom level may be determined based on a number of pins 310 and/or grouped pins 320 in an area. For example, if a user requests a map view 300, the map view 300 may be centered on the client device 130 location (or elsewhere, as described below), and a predetermined number of pins 310 and/or grouped pins 320 may be displayed. For example, the five nearest pins 310 and/or grouped pins 320 to the client device 130 location may be displayed on the map view 300. The map view 300 may be initially zoomed in to a level that is as far as possible while displaying each of the five nearest pins 310 and/or grouped pins 320. Five is used as an example, and other numbers of pins 310 and/or grouped pins 320 may be displayed. As zoom levels change and/or as a map is scrolled (for example, due to user input), pins 310 and/or grouped pins 320 that are located within the displayed area may be added to the map 300, and pins 310 and/or grouped pins 320 that are no longer located within the displayed area may be removed from the map view 300.

Each moment may also be associated with a moment view 330, which may provide details about the moment. For example, a moment view 330 may include the name and/or username of the user who posted the moment, a date and/or time at which the moment took place, an address and/or location of the moment, a written description, a photo or icon describing the moment, one or more selectable links enabling actions to be performed on the moment (such as viewing more details; sharing the moment via a different social network such as Pinterest, Twitter, or Facebook; emailing the moment to an email address; etc.) and/or other elements. The moment view 330 may provide a link for reporting abuse, which, when selected, may send a request to a web server 126 to disable the moment, may remove the moment's pin 310 from the map view 300, and/or cause a message to be displayed to the user that caused the pin to be displayed. A moment view 330 may be displayed when a user clicks on or otherwise selects a pin 310 corresponding to the moment and/or when a link to the map view 300 associated with the moment is followed. For example, if a user clicks on a link to a moment shown in the stored content 220 display and/or the ticker 230 of the landing page 200, that moment's view 330 may subsequently be displayed on the map view 300. Clicking on a grouped pin 320 may cause information about the moments in the group to be displayed, allowing a user to select individual moments in the group to be displayed in a moment view 330. Selecting a moment and/or following a link associated with a moment may cause the associated moment view 330 to be centered on the map view 300. For example, the map view 300 may be centered on the moment location instead of a default client device 130 location when a link is followed.

The map view 300 may include a list of moments 340, which may contain some or all of the moments associated with pins 310 and/or grouped pins 320 currently shown on the map view 300. The list 340 may be able to display a limited number of moments, which may depend on the size of a client device's 130 display screen and/or the size of the moment displays in the list 340. If more moments are pinned on the map view 300 than can fit in the list 340, the list 340 may be scrollable. When the list 340 is scrolled and the scroll reaches the bottom (or top), a request for the next moments in the list 340 may be made by the client device 130 so they can be displayed.

The map view 300 may include a search tool 350. The search tool 350 may be, for example, a free text search box. The search tool 350 may use an API 146 such as the Google places API (or iOS equivalent) and/or another service for auto fill and/or suggestions. Users of the client device 320 may be able to search for moments corresponding to entered search terms, and some or all search results may be displayed on the map view 300. The search tool 350 may use tags associated with moments to filter the moments in a search and/or may present tag links to a user for selection. A user may click on a tag link and view moments related to that tag. The map view 300 may display a list of tags which may be selected by a user. For example, the list of tags may be accessed by clicking a button or link (e.g., a “tags” button or link) which may be included on the map view 300.

A user may also be able to select moments based on other attributes, such as a user name associated with the poster of the moment. For example, a user may be able to “follow” a user name and may be automatically shown new moments the followed user adds. Users may also be able to bookmark moments, and these moments may be added to a list of favorite moments which may be accessible through a button or link on the map view 300. Additionally, a user may be able to add comments to a selected moment, and these comments may be visible to other users of the social network 100. In some embodiments, the comments may be subject to moderator approval before display, or may be only visible to certain users of the social network 100 (e.g., Facebook friends of the user, as described below). In some embodiments, the user may be able to select which users or groups of users are able to view their comments. The social network 100 may allow the user who created a moment to edit and/or remove comments from their own moments in some embodiments.

The map view 300 may also include a timeline 360. The timeline 360 may allow data displayed on the map view 300, such as user generated or social network 100 provider generated moments, to be filtered based on an associated date and/or time. For example, the timeline 360 may allow a user to display only moments that occurred in a particular year or other unit of time. When a map view 300 is loaded on a client device 130, the timeline 360 may default to allowing display of moment pins 310, grouped pins 320, and/or moment views 330 associated with all possible times. A user of a client device 130 may select portions of the timeline 360 to specify a period of time for which to display moments. If a user inputs a request to narrow, broaden, and/or change a period of time for which to display moments, pins 310 and/or grouped pins 320 that are located within the displayed area and took place during the selected period of time may be added to the map view 300, and pins 310 and/or grouped pins 320 that are located within the displayed area but did not take place during the selected period of time may be removed from the map view 300. As the map view 300 is zoomed and/or scrolled, only moment pins 310 and/or grouped pins 320 associated with the selected time period may be added to the display.

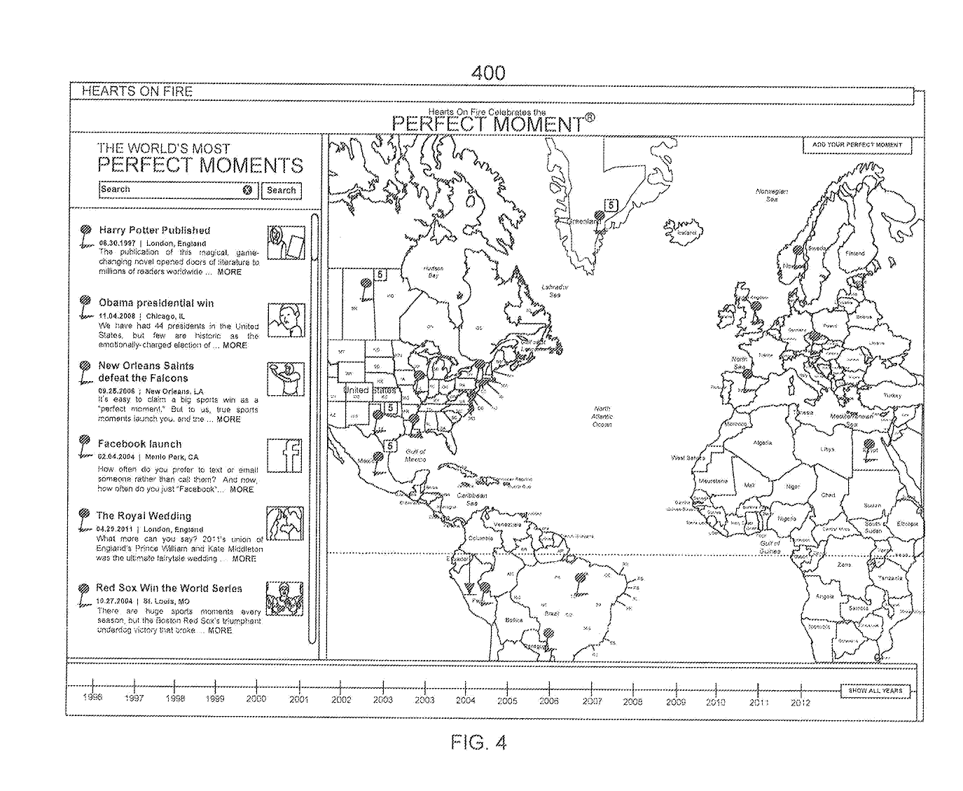

FIG. 4 depicts an example world view 400 according to an embodiment of the invention. A user of a client device 130 may have the ability to select the world view 400, and/or the world view 400 may be displayed when a user requests the map view 300 and does not supply a location (or if client device 130 location via GPS, cell triangulation, etc. is disabled and/or unavailable). The world view 400 may display a map of the world with moment pins 310 and/or grouped pins 320. The world view 400 may be zoomed in by a user and behave as a map view 300 described above.

FIG. 5 depicts an example map view 300 with an example add moment form 510 according to an embodiment of the invention. When a user of a client device 130 selects an “add moment” link from the landing page 200 or otherwise requests to add a moment, the add moment form 510 may be displayed. In some embodiments, the features and fields of the add moment form 510 described below may be split among a plurality of forms. For example, a user may enter some information and click a button or link to advance to the next form to enter more information. The add moment form 510 may be displayed over a map view 300 as shown in FIG. 5, or the add moment form 510 may be a separate display. The add moment form 510 may include one or more fields allowing a user to enter information about the moment. For example, and add moment form 510 may include fields for a user name and/or real name, a date (for example, month/day/year) for the moment, an email address of the user, a text description of the moment, a selection of one or more tags (key words associated with the moment that may be entered by the user and/or provided for selection within the add moment form 510), and/or other fields. Some data may be stored for use in future input. For example, a user's name and email address may be stored the first time a user adds a moment and may be automatically inserted into the add moment form 510 fields when the user adds additional moments. Some or all of these fields may be required in order to submit the moment with the add moment form 510. Associating the moment with a date and/or time may facilitate sorting of moments with a timeline 360 as described above. The add moment form 510 may use the current client device 130 location as the location for the moment and/or may allow the user to enter another location for the moment.

The add moment form 510 may also allow the user to add a photo or other image to the moment. For example, the add moment form 510 may contain user-selectable options to upload a photo from an outside source such as Instagram, Facebook, or Pinterest, use a photo within a library associated with the client device 130, use a camera on the client device 130 to take a photo, and/or select a photo (such as a default or stock photo) available through the social network 100. The add moment form 510 may allow a user to edit a selected photo. In some embodiments, if a user uploads or takes a photo, the client device 130 may prompt the user to choose whether to use the photo's original geolocation or the device's 130 current location. For example, some embodiments (such as iPhone applications) may be able to use third party plugins to look for geolocation data attached to a photograph. If geolocation data is found, it may be used to associate the photo with a position on the map. When a user has completed entry of moment information, the client device 130 may transmit the moment information to the web server 126, which may allow the computers providing social network services 120 to incorporate the moment into the social network. When the moment has been incorporated into the social network 100, users may be able to view the moment on the landing page 200 ticker 230 and/or on the map page 300 as described above.

As noted above, the add moment form 510 may allow adding photos from external sources. For example, the system may connect to the user's Instagram, Facebook, Pinterest or other media sharing account and allow the user to select photos from the user's account for use in the social network 100. Many media sharing services may allow third party applications to interface with their systems to provide this functionality. The social network 100 may take advantage of this interfacing functionality to connect with and retrieve media from, for example, an Instagram, Facebook, or Pinterest account for which the user has provided access credentials. In some cases, a user may be able to create an account with the social network 100 using an account from one of these services. For example, a Facebook account may be used to register with the social network 100, and a user may be able to log into their Facebook account to access the social network. In this scenario, the social network 100 may be able to identify moments made by Facebook friends of the user and present them to the user, for example. Users may be able to follow Facebook friends within the social network 100 to see new moments as they are posted by the Facebook friends. In other cases, a user may create a standalone account with the social network 100 and interface with the external media sharing account later.

FIG. 6 depicts an example map control process 600 according to an embodiment of the invention. As noted above, the map view 300 may be manipulated by a user and/or changed automatically by the client device 130 to zoom, scroll, add or remove pins 310 and/or grouped pins 320, center on a location, and/or perforni other actions. A map control process 600 may be performed by a computer, for example the client device 130, to control map functions. A map control application may be loaded 605 by the client device 130. This may occur in response to a user of a client device 130 clicking a link associated with a moment or a link requesting a map view as described above, for example. Loading 605 the map control application may cause map control to initialize 635. Map control may initialize 635 in response to a map application window being resized 610 as well. Map control may serve as an interface between the client device 130, the APIs 142, 144, 146, and the social network services computers 120. Map control may include logic for the interaction of user requests and the display of data. For example, map control may listen for a “map panned” event from the map API 144, which may be generated in response to a user command to pan the map. When that event is fired, map control may request new boundaries for the viewable map. Map control may receive and pass this information to the data server 122 (via the web server 126) to get any relevant data. Map control may listen for a response from the web server 126 and once data is received, map control may instruct the map API 144 to appropriately render that data. Map control may also handle other functions such as browser geolocation detection and the like.

Some map control functions may be performed by different computers in different embodiments. For example, a client device 130 may be a PC running a web browser program. The web browser may be used to interface with the web server 126 and map API 144. The map may be supplied by the map API 144, and other map control processing may be performed by the data server 122 and transmitted by the web server 126. For example, the data server 122 may determine pin 310 placement and cause the pins 310 to be rendered in appropriate locations on the map within the client device 130 browser window. In another embodiment, a client device 130 may be a smart phone running a dedicated app. The map may be supplied by the map API 144, and at least some other map control processing may be performed by the app itself. For example, the app may determine pin 310 placement and cause the pins 310 to be rendered in appropriate locations on the map within the client device 130 display.

When map control is initialized 635, the client device 130 may next determine a starting location for the map. The client device 130 may determine whether it supports geolocation 640, whether the client device's 130 location can be determined by its associated IP address 645, and/or whether a user of the client device 130 has inputted a starting and/or current location 650 (for example after being prompted to enter a location upon requesting a map view 300). If none of these conditions are satisfied, the client device 130 may set the map zoom level to a maximum zoom level 685 (which may, for example, result in a world view map being displayed). If one of these conditions are satisfied, the map may be given a starting coordinate 655 based on the determined location. Note that only one condition may need to be satisfied. Once a condition is satisfied, the client device 130 may stop checking the other conditions. The most accurate condition may be used (for example, in this order: browser geolocation, IP geolocation, and user entered location). After a starting coordinate is assigned 655, the client device 130 may determine or request a number of moment location points (i.e. pins 310 and/or grouped pins 320) that are closest to the starting coordinate 660. In the example of FIG. 6, five points are requested from a data server 122. The client device 130 may calculate a map zoom level and map boundaries based on the points 665. After the zoom level and boundaries are calculated 665, after the map zoom level is set to maximum 685, and/or after a user command to zoom and/or pan the map 615, the area of the map to be displayed may be defined. Therefore, the client device 130 may deteimine or request the moment location points (i.e. pins 310 and/or grouped pins 320) that are within the established map boundaries 670. Pins 310 and/or grouped pins 320 may be added to the map for each point 675, and a list view 340 item may be generated for each point 680.

When a map application window is resized 610, in addition to initializing map control 635, the client device 130 may calculate dimensions and placements of window controls 620 (for example, the moment list 340, search tool 350, timeline 360, and/or other controls). The client device 130 may attach control events to animated controls 625 and track the status of animated controls 630. Animated controls may include sliding panes (for example, the moment list 340 and the timeline 360, each of which may scroll and/or change in an animated manner when data changes and/or in response to user selection). The client device 130 may monitor for changes in window size and recalculate the dimensions of these sliding panes. The client device 130 may keep track of a current display status (for example, open or closed) and may update scrolling control position and/or scrollable area for the sliding panes. The client device 130 may also accept commands from other pieces of the application to open/close/resize these animated controls.

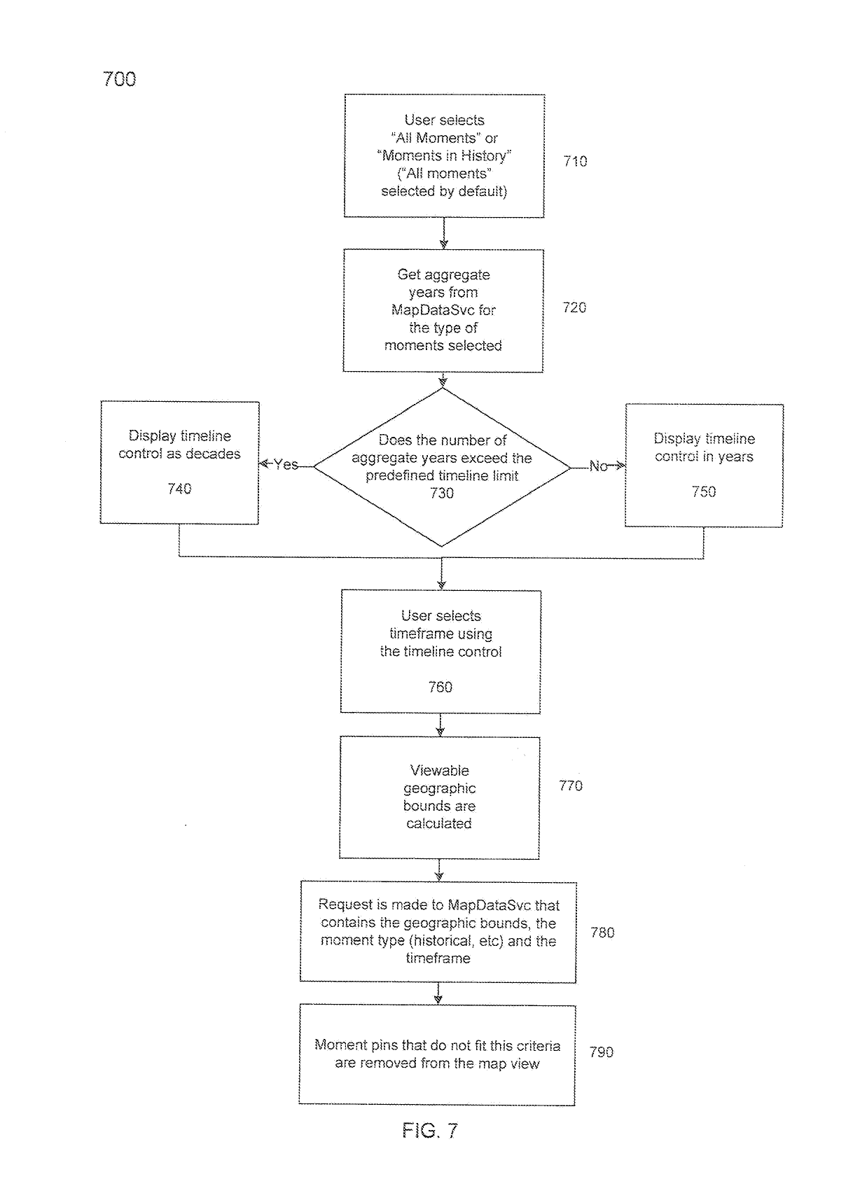

FIG. 7 depicts an example timeline control process 700 according to an embodiment of the invention. As noted above, a user may be able to use a timeline 360 to filter moments based on when they occurred. A user of a client device 130 may view moments from all available sources, such as users and the social network provider (i.e. “all moments”, which may be a default selection), or may choose to view only moments added by the social network provider (i.e. by selecting “moments in history” 390 as seen in FIG. 3) 710. The client device 130 may determine or receive data from social network services 120 computers about the aggregate time frame (or all times when “all moments” is selected) for a type of moment selected 720. For example, the social network services 120 computers may determine the range of time necessary to include all moments of the selected type. In the example of FIG. 7, the times available for selection are divided into years, but other units of time may be used in other embodiments. The social network services 120 computers may determine whether the number of aggregate years exceeds a timeline 360 limit 730. If the limit is exceeded, the timeline 360 may be displayed in decades 740. If the limit is not exceeded, the timeline 360 may be displayed in years 750. When these determinations have been made, a timeline 360 may be displayed to a user of the client device 130. The determination of whether the number of years exceeds the limit may be made based on a predefined number of years (for example, 20 years). After the social network services 120 computers collects data that spans over 20 years, the timeline 360 may switch to a decade view, which may present a view to a user which is less crowded than if more than the predefined number of years is displayed on the timeline 360. The user may select a particular time frame of interest using the timeline 360 control 760, for example by clicking on a year or highlighting multiple years in the timeline 360. In response, the client device 130 may first calculate viewable geographic bounds 770. Geographical bounds may be calculated using a south west latitude and longitude and a northeast latitude and longitude, for example, effectively creating a rectangle on a map. The client device 130 may set minimum and maximum bounds with these coordinates for a request to the data server 122. Additional mathematical logic may be used to calculate and take into account the great circle distance (curvature of the earth) and to account for a situation wherein a user pans the map in a way that the southwest coordinates are greater than the north east coordinates (or other unusual and/or unexpected conditions. The client device 130 may determine or request geographic bounds, a moment type, and/or a time frame corresponding to the selections made by the user 780. Moment pins 310 and/or grouped pins 320 that do not fit within the bounds, moment type, and/or time frame may be removed from the map 790. For example, moments that took place at a time outside of the selected time frame may not be displayed on the map view 300 of the client device 130. Note that grouped pins 320 may represent different groupings of moments if only some of the grouped moments are removed by this process 700.

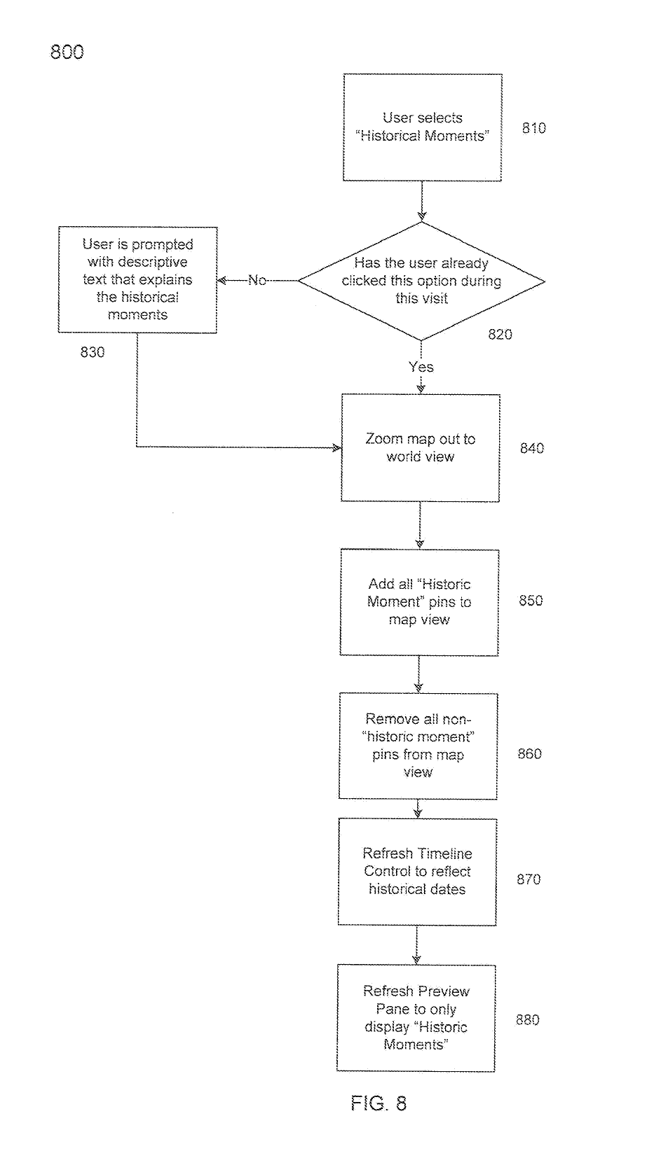

FIG. 8 depicts an example moment in history process 800 according to an embodiment of the invention. This example process 800 may be used to display data that is provided by the social network provider only (for example, “historical moments”) and filter out other data (for example, user generated moments). In other embodiments, some or all of this process 800 may filter displayed information based on other criteria. First, a user of a client device 130 may request to filter displayed data 810, for example by selecting a “historical moments” option on the landing page 200 or map view 300. The client device 130 may determine whether a user has made this selection before 820, and if not, the user may be presented with an explanation of the historical moments option 830. If so, or after displaying the explanation 830, the map may be zoomed out 840 to a world view 400. Historic moment pins 310 and/or grouped pins 320 may be added to the map 850 and non-historic moments may be removed from the map 860. The timeline control may be refreshed to encompass the dates in which the displayed historic moments took place 870, and the moment list 340 may be refreshed to only display historic moments 880.

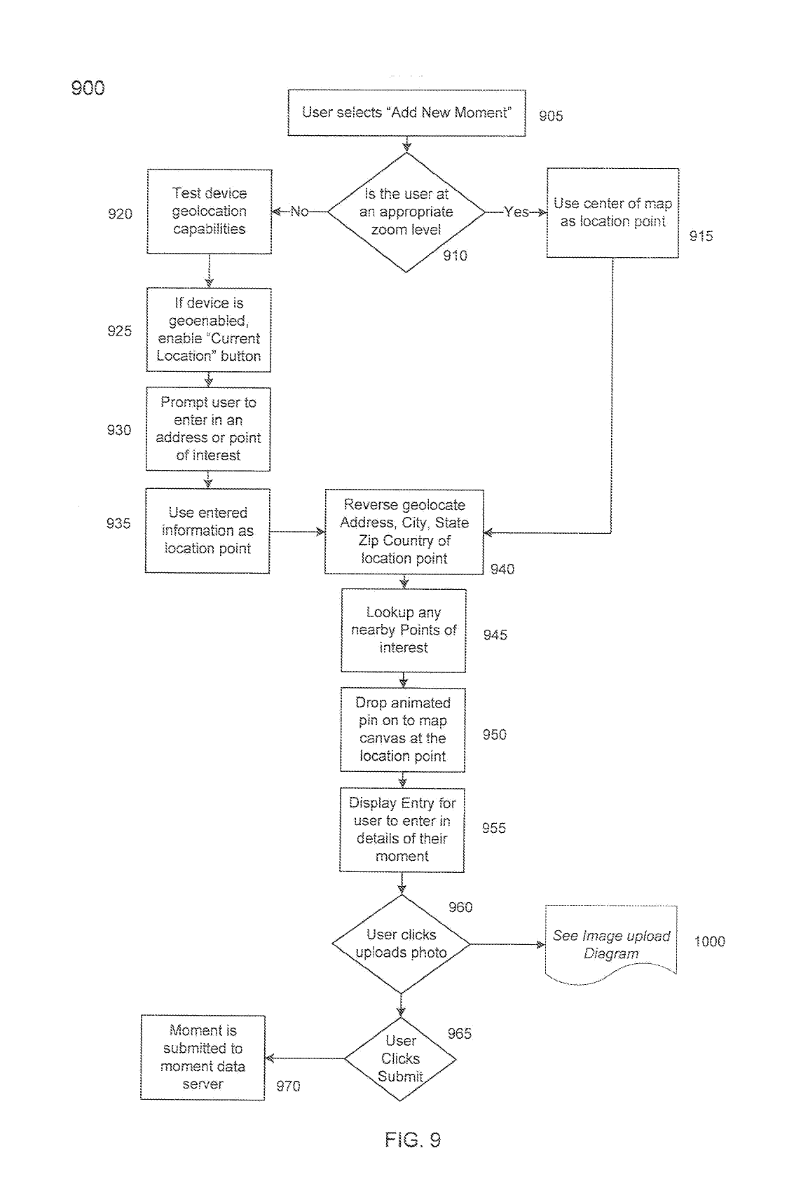

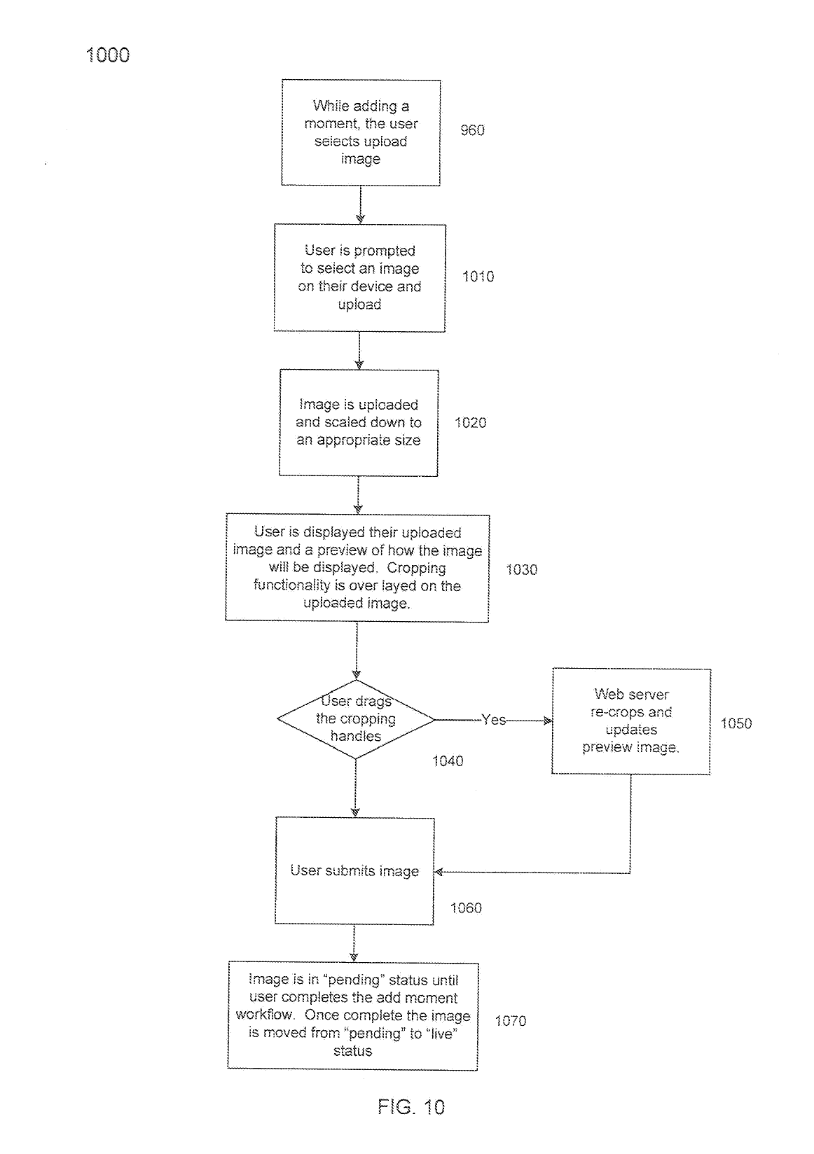

FIG. 9 depicts an example add moment process 900 according to an embodiment of the invention. As noted above, a user of a client device 130 may be able to share moments with other users of the social network 100. To begin this process 900, a user may, at 905, select an “add new moment” link 211 or similar option on the landing page 200, an “add new moment” link 380 or similar option on the map view 300, and/or via some other interface. The client device 130 may determine whether the map view 300 is at an appropriate zoom level 910. For example, an appropriate zoom level may be a predetermined default zoom level. If the map view 300 is at an appropriate zoom level, the center of the map may be used as a location point for adding the moment 915. If the map view 300 is not at an appropriate zoom level, the client device's 130 geolocation capabilities may be tested 920. If the client device 130 can determine its location (for example using GPS or cell triangulation), a “use current location” option for setting a moment location may be enabled 925. Whether a “use current location” option is provided 925 or not, an option to allow a user to define a moment location (for example by entering an address or point of interest) may be provided 930. Information entered by a user into the client device 130, such as a “use current location” selection or entered address or point of interest may be used as a location point for adding the moment 935. Once a location point is determined based on the center of the map 915 or selected location 935, the social network services 120 computers may reverse geolocate location data for the location point 940. For example, the social network services 120 computers may determine the address, city, state, zip code, and/or country of the location point. The social network services 120 computers may also determine whether there are any points of interest (such as landmarks, locations of historic moments, and/or other points of interest) near the location point 945. For example, a user may identify the location and, using reverse lookups, the social network services 120 computers may make suggestions regarding nearby points of interest. The social network services 120 computers may also record city, state, country data for display purposes and future filtering. The client device 130 may place an animated pin 310 on the map at the location point 950. For example, the pin 310 may be animated upon placement to appear to drop from above. This animation may provided by the maps API 144 in some embodiments. The client device 130 may display a dialog box enabling a user to enter details about the moment 955. The dialog box may be immediately shown after the pin animation. The client device 130 may also determine whether the user has opted to upload an image associated with the moment 960, for example by clicking an “upload photo” link or button. If the user wishes to upload an image, an image upload process 1000 may be initiated. (An example image upload process is described below with respect to FIG. 10.) If the user does not wish to upload an image, the user may submit the moment to the social network 100, for example by clicking a “submit” link or button 965. The client device 130 may submit the moment 970 to a data server 122. The server 122 may add the moment to the social network 100 such that it may be viewed by other users, may hold the moment for review by an administrator before making it viewable, and/or perform other actions on the moment.

FIG. 10 depicts an example image upload process 1000 according to an embodiment of the invention. When a user creates a new moment, they may choose to upload an image to associate with the moment 960. The client device 130 may cause the user to be prompted to select an image on the client device 130 for upload 1010. The user may select an image in a library on the client device 130, select an image from an external source such as Instagram, Facebook, or Pinterest, and/or take a photo with a camera incorporated into the client device 130. The selected or created image may be uploaded and scaled 1020 to a size that may be suitable for display in a moment view 330, moment list 340, ticker 230, and/or other location. The resized image may be displayed to the user 1030. The user may be able to crop and/or otherwise edit the image. For example, the client device 130 may detect that a user has dragged cropping handles 1040 to crop the image. If so, the social network services 120 computers may crop the image and update the preview image accordingly 1050. After the image is cropped, or if no editing is performed, the user may approve and submit the image 1060. The image may be held in a “pending” status until the moment submission process 900 is completed. Once the moment is submitted, the image may be given a “live” status 1070, and may be displayed, along with the other moment information, to users of the social network 100 as described above.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, although the specification describes certain functions as being performed by the client device 130 or social network services 120 computers, those skilled in the art will appreciate that those functions can be performed by the other of the client device 130 or social network services 120 computers or by any other computers. Thus, the present embodiments should not be limited by any of the above-described embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “the”, “said”, etc. also signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A method comprising:
receiving, with a computer, temporal and geographic data comprising a location and a moment in time, the location and the moment in time being linked to one another, and the temporal and geographic data being associated with an icon linked to a position on a map corresponding to the location;
receiving, with the computer, a command to filter the icon based on a period of time;
causing, with the computer, a portion of the map to be displayed;
causing, with the computer, the icon to be displayed at the linked position on the portion of the map when the moment in time is within the period of time and the location is within the portion of the map; and
determining, with the computer, that the icon is not to be displayed when the moment in time is not within the period of time and/or when the location is not within the portion of the map.

2. The method of claim 1, further comprising:
receiving, with the computer, a command to zoom and/or pan the portion of the map to a new portion of the map;
causing, with the computer, the new portion of the map to be displayed;
causing, with the computer, the icon to be displayed at the linked position on the new portion of the map when the moment in time is within the period of time and the location is within the new portion of the map; and
determining, with the computer, that the icon is not to be displayed when the moment in time is not within the period of time and/or when the location is not within the new portion of the map.

3. The method of claim 1, further comprising:
receiving, with the computer, a command to change the period of time to a new period of time;
causing, with the computer, the icon to be displayed at the linked position on the portion of the map when the moment in time is within the new period of time and the location is within the portion of the map; and
determining, with the computer, that the icon is not to be displayed when the moment in time is not within the new period of time and/or when the location is not within the portion of the map.

4. The method of claim 1, further comprising causing, with the computer, moment data associated with the temporal and geographic data to be displayed.

5. The method of claim 4, wherein the moment data comprises the location, a date and/or time identifying the moment in time, a user name associated with the temporal and geographic data, a text description associated with the temporal and geographic data, and/or an image associated with the temporal and geographic data.

6. The method of claim 1, further comprising causing, with the computer, a list of moments associated with the temporal and geographic data to be displayed.

7. The method of claim 1, further comprising causing, with the computer, an interface for accepting the command to filter the icon based on the period of time to be displayed.

8. The method of claim 1, further comprising causing, with the computer, an interface for accepting a command to choose the temporal and geographic data based on a search term and/or a tag to be displayed.

9. The method of claim 8, further comprising selecting, with the computer, the temporal and geographic data based on the command to choose the temporal and geographic data based on a search term and/or a tag.

10. The method of claim 1, wherein the portion of the map is determined based on the location.

11. The method of claim 1, wherein the portion of the map is determined based on a location of the computer or the location of a remote device.

12. The method of claim 1, wherein the portion of the map is a world map when a location of the computer or a remote device is unknown.

13. The method of claim 1, wherein the temporal and geographic data is received via a network.

14. The method of claim 1, wherein the temporal and geographic data is received via a user interface associated with the computer, further comprising transmitting, with the computer, the temporal and geographic data received from the user interface to a server via a network.

15. The method of claim 14, further comprising receiving, with the computer, a user name associated with the temporal and geographic data, a text description associated with the temporal and geographic data, and/or an image associated with the temporal and geographic data.

16. The method of claim 15, further comprising transmitting, with the computer, the user name associated with the temporal and geographic data, the text description associated with the temporal and geographic data, and/or the image associated with the temporal and geographic data to the server via the network.

17. The method of claim 15, wherein the computer receives the user name associated with the temporal and geographic data, the text description associated with the temporal and geographic data, and/or the image associated with the temporal and geographic data via the user interface associated with the computer.

18. The method of claim 15, wherein the computer receives the user name associated with the temporal and geographic data, the text description associated with the temporal and geographic data, and/or the image associated with the temporal and geographic data via an external network.

19. The method of claim 18, wherein the external network comprises Facebook, Instagram, and/or Pinterest.

20. The method of claim 1, wherein causing the icon to be displayed at the linked position on the portion of the map comprises:
determining that temporal and geographic data corresponding to two or more moments in time respectively corresponds to a substantially similar location; and
causing a grouped icon associated with the temporal and geographic data corresponding to each of the two or more moments in time to be displayed.

21. The method of claim 20, wherein the grouped icon comprises a representation of a quantity of the two or more moments.

22. The method of claim 1, wherein:
the computer is a client device comprising a display;
the computer causes the portion of the map to be displayed on the display; and
the computer causes the icon to be displayed on the display.

23. The method of claim 1, wherein:
the computer causes the portion of the map to be displayed on a display associated with a remote device; and
the computer causes the icon to be displayed on the display associated with the remote device.

24. A system comprising:
a processing circuit constructed and arranged to:
receive temporal and geographic data comprising a location and a moment in time, the location and the moment in time being linked to one another, and the temporal and geographic data being associated with an icon linked to a position on the map corresponding to the location;
receive a command to filter the icon based on a period of time;
cause a display to display a portion of the map;
cause a display to display the icon at the linked position on the portion of the map when the moment in time is within the period of time and the location is within the portion of the map; and
determine that the icon is not to be displayed on the display when the moment in time is not within the period of time and/or when the location is not within the portion of the map.

25. The system of claim 24, wherein the processing circuit is further constructed and arranged to:
receive a command to zoom and/or pan the portion of the map to a new portion of the map;
cause the display to display the new portion of the map;
cause the display to display the icon at the linked position on the new portion of the map when the moment in time is within the period of time and the location is within the new portion of the map; and
determine that the icon is not to be displayed when the moment in time is not within the period of time and/or when the location is not within the new portion of the map.

26. The system of claim 24, wherein the processing circuit is further constructed and arranged to: receive a command to change the period of time to a new period of time;
cause the display to display the icon at the linked position on the portion of the map when the moment in time is within the new period of time and the location is within the portion of the map; and
determine that the icon is not to be displayed when the moment in time is not within the new period of time and/or when the location is not within the portion of the map.

27. The system of claim 24, wherein the processing circuit is further constructed and arranged to cause the display to display moment data associated with the temporal and geographic data.

28. The method of claim 27, wherein the moment data comprises the location, a date and/or time identifying the moment in time, a user name associated with the temporal and geographic data, a text description associated with the temporal and geographic data, and/or an image associated with the temporal and geographic data.

29. The system of claim 24, wherein the processing circuit is further constructed and arranged to cause the display to display a list of moments associated with the temporal and geographic data.

30. The system of claim 24, wherein the processing circuit is further constructed and arranged to:
cause the display to display an interface for accepting the command to filter the icon based on the period of time; and
receive the command to filter the icon based on the period of time.

31. The system of claim 24, wherein the processing circuit is further constructed and arranged to: cause the display to display an interface for accepting a command to choose the temporal and geographic data based on a search term and/or a tag; and
receive the command to choose the temporal and geographic data based on the search term and/or the tag.

32. The system of claim 31, wherein the processing circuit is further constructed and arranged to select the temporal and geographic data based on the command to choose the temporal and geographic data based on a search term and/or a tag.

33. The system of claim 24, wherein the portion of the map is determined based on the location.

34. The system of claim 24, further comprising a location device, wherein the portion of the map is determined based on a location of the location device.

35. The system of claim 24, further comprising a location device, wherein the portion of the map is a world map when a location of the location device is unknown.

36. The system of claim 24, wherein the temporal and geographic data is received via a network.

37. The system of claim 24, further comprising a user interface, wherein:
the temporal and geographic data is received via the user interface; and
the processing circuit is further constructed and arranged to transmit the temporal and geographic data received from the user interface to a server via a network.

38. The system of claim 37, wherein the processing circuit is further constructed and arranged to receive a user name associated with the temporal and geographic data, a text description associated with the temporal and geographic data via the user interface, and/or an image associated with the temporal and geographic data via the user interface.

39. The system of claim 38, wherein the processing circuit is further constructed and arranged to transmit the user name associated with the temporal and geographic data, the text description associated with the temporal and geographic data, and/or the image associated with the temporal and geographic data to the server via the network.

40. The system of claim 38, wherein the processing circuit is constructed and arranged to receive the user name associated with the temporal and geographic data, the text description associated with the temporal and geographic data, and/or the image associated with the temporal and geographic data via the user interface.

41. The system of claim 38, wherein the processing circuit is constructed and arranged to receive the user name associated with the temporal and geographic data, the text description associated with the temporal and geographic data, and/or the image associated with the temporal and geographic data via an external network.

42. The system of claim 41, wherein the external network comprises Facebook, Instagram, and/or Pinterest.

43. The system of claim 24, wherein displaying the icon at the linked position on the portion of the map comprises:
determining that temporal and geographic data corresponding to two or more moments in time respectively corresponds to a substantially similar location; and
displaying a grouped icon associated with the temporal and geographic data corresponding to each of the two or more moments in time.

44. The system of claim 43, wherein the grouped icon comprises a representation of a quantity of the two or more moments.

45. The system of claim 24, further comprising the display.

46. The system of claim 24, wherein:
the display is a component of a remote computer; and
the processing circuit is in communication with the remote computer via a network.

47. The system of claim 24, wherein the portion of the map is determined based on a location of a remote device.

48. The system of claim 24, wherein the portion of the map is a world map when a location of a remote device is unknown.

49. The system of claim 24, wherein the temporal and geographic data is received from a remote device.

50. The system of claim 49, wherein the processing circuit is further constructed and arranged to receive a user name associated with the temporal and geographic data from the remote device, a text description associated with the temporal and geographic data from the remote device, and/or an image associated with the temporal and geographic data from the remote device.

51. The method of claim 7, wherein the interface for accepting the command to filter the icon based on the period of time to be displayed is a timeline comprising a plurality of time increments.

52. The method of claim 51, wherein causing the interface for accepting the command to filter the icon based on the period of time to be displayed comprises:
determining whether the period of time exceeds a time limit;
causing a first set of time increments to be displayed on the timeline when the period of time does not exceed the time limit;
causing a second set of time increments to be displayed on the timeline when the period of time exceeds the time limit, the second set of time increments representing larger units of time than the first set of time increments.

53. The method of claim 51, further comprising generating, with the computer, the command to filter the icon based on the period of time by receiving a selection of one or more of the plurality of time increments and determining the period of time based on the selection.

54. The system of claim 30, wherein the interface for accepting the command to filter the icon based on the period of time to be displayed is a timeline comprising a plurality of time increments.

55. The system of claim 54, wherein the processing circuit is constructed and arranged to cause the display to display an interface for accepting the command to filter the icon based on the period of time by:
determining whether the period of time exceeds a time limit;
causing the display to display a first set of time increments on the timeline when the period of time does not exceed the time limit;
causing the display to display a second set of time increments on the timeline when the period of time exceeds the time limit, the second set of time increments representing larger units of time than the first set of time increments.

56. The system of claim 54, wherein the processing circuit is further constructed and arranged to generate the command to filter the icon based on the period of time by receiving a selection of one or more of the plurality of time increments and determining the period of time based on the selection.
